(19) United States
(12) Patent Application Publication
(10) Pub. No.: US 2023/0043668 A1
(43) Pub. Date: Feb. 9, 2023

(54) Single Node Home Deployment with Local Breakout

(71) Applicant: Celona, Inc., Cupertino, CA (US)

(72) Inventors: Srinivasan Balasubramanian, San Diego, CA (US); John Taylor, Cupertino, CA (US); Shashideep Nuggehalli, Cupertino, CA (US); Mehmet Yavuz, Palo Alto, CA (US); Puneet Prabhakar Shetty, San Francisco, CA (US)

(21) Appl. No.: 17/393,312

(22) Filed: Aug. 3, 2021

(51) Int. Cl. H04W 8/26; H04W 88/16; H04W 8/08; H04W 76/12

(52) U.S. Cl. CPC H04W 8/26; H04W 88/16; H04W 8/08; H04W 76/12

(57) ABSTRACT

In selected embodiments, on-premises equipment of a cellular network provides local breakout functionality so that user plane data packets (PDNs/PDUs) are routed between the home/enterprise network and the Internet directly, bypassing a cloud-based core of the cellular network. The UE's control traffic is still routed to/from the core. The core may be an Evolved Packet Core (EPC) in a 4G LTE network, or a 5G Core (5GC) in a 5G network. The UE's IP addresses may be assigned by the core, or locally, by the on-premises equipment. Providing the IP context from the on-premises network allows the UE to connect to local devices, e.g., printers, disc raids, gaming and streaming nodes, and other local devices. The local IP context also pushes the complexity of the EPC core deployment to the cloud while reducing the overhead of cloud processing that comes with user plane data processing.

### BACKGROUND

### (1) Technical Field

The disclosed methods, apparatus, and articles of manufacture generally relate to communications networks and in particular, to home deployment of communication nodes with local breakout.

### (2) Background

A typical communication system home deployment kit provides all of the necessary equipment to complete a home installation. Such a communication system home deployment kit includes an eNodeB (“eNB”), an evolved packet core node (“EPC”), a router/modem, and a power supply. However, properly interconnecting these components is not easy for a typical non-technical person. Internet Protocol (IP) packets transmitted from User Equipment (a “UE”) through local base station/access point (BS/AP) may need to be processed by Internet Protocol Security (“IPSec”) and travel through the router/modem to the public Internet and then from the public Internet to the core of the mobile network operator (“MNO”), and then back again through the public Internet to the desired website or another Internet/Intranet resource. Thus, the packets enter and exit the public Internet twice. This can cause extra processing by the core and result in an undesirable delay. Furthermore, the core may need to process the packets even when the packets are not part of a telephone call originated or received by the UE. Accordingly, there is currently a need in the art for a method and apparatus to reduce the delays and the processing load on the core. There is also a need in the art to simplify installation of deployment kits by reducing the number of separate components and interconnections among these components.

These considerations and needs also pertain to system home deployment kits for 5^{th} Generation (5G) installations.

### SUMMARY

A method and apparatus is disclosed in which some embodiments include on-premises equipment (i.e., equipment located in a home or within an enterprise campus, such as the site of a business on which a private enterprise network is deployed) that includes an eNodeB (“eNB”), gNodeB (“gNB”), an access point or a generic base station (hereafter referred to broadly as a base station/access point (“BS/AP”) for the sake of brevity. The BS/AP is configured to communicate with User Equipment (a “UE”) over a wireless connection, a router/modem and additional functionality that assists with managing communications between the on-premises equipment and either a cloud based network core (e.g., EPC/5GC) or services (e.g., a packet data network/protocol data unit (PDN/PDU) in the internet). The BS/AP is connected to the Internet through the router/modem. In some embodiments, the network core is implemented with one or more computers executing core code.

In some embodiments, the on-premises equipment is configured so that the UE communicates user traffic directly with PDNs/PDUs and other services, while the control signaling (S1-C/N2) to and from the on-premises equipment goes from and to the EPC/5GC, terminating at the EPC/5GC. In some embodiments, internet protocol (IP) addresses to allow the UE to communicate directly with the resources are assigned and/or released by the on-premises equipment. In other embodiments, such IP address are assigned and/or released by the EPC/5GC.

In some embodiments, all of the on-premises equipment is housed in a common housing to simplify installation of the on-premises equipment, with connections between various components of the on-premises equipment being pre-established prior to installation. In addition, in some embodiments, power is supplied to the on-premises equipment by a power over ethernet (PoE) connection, further simplifying the installation. All control plane communications between the on-premises equipment and the network core flow through the internet. In addition, a local breakout (LBO) entity provides a mechanism for allowing use plane communications to and from the on-premises equipment to be routed directly to services requested by a UE communicating through the on-premises equipment.

Various features and aspects will be better understood with reference to the following detailed description, drawings, and claims.

### BRIEF DESCRIPTION OF THE DRAWINGS

The disclosed methods, apparatus, and articles of manufacture in accordance with one or more various embodiments, are described with reference to the following drawings. The drawings are provided for purposes of illustration only and merely depict examples of some embodiments of the disclosed methods, apparatus, and articles of manufacture. When the drawings are reviewed in conjunction with a careful perusal of this specification, they facilitate the reader's understanding of the disclosed techniques. The drawings should not be considered to limit the breadth, scope, or applicability of this description. It should be noted that for clarity and ease of illustration these drawings are not necessarily made to scale.

FIG. 1 illustrates selected parts of a communication system combining a User Equipment (UE), an on-premises router/modem connected to the Internet, a 4G LTE cellular communication network, and various IP Services and Resources;

FIG. 2 illustrates selected parts of a 4G LTE communication system configured in accordance with selected aspects described in this document.

FIG. 3A illustrates selected parts of a 5G communication system configured in accordance with some embodiments of the disclosed method and apparatus in which an N11 interface exists between on-premises equipment and an Access and Mobility Management Function (AMF) within a 5G Core (5GC).

FIG. 3B illustrates selected parts of a 5G communication system configured in accordance with some embodiments of the disclosed method and apparatus in which a modified N2 interface between on-premises equipment and the 5GC provides a locally generated Internet Protocol (IP) address to an AMF.

FIG. 4 illustrates selected parts of a modified 4G/5G network architecture with local breakout, in accordance with selected aspects described in this document.

FIG. 5 is a flowchart showing selected steps of a communication process with local breakout, in accordance with selected aspects described in this document.

FIG. 6 is a flowchart showing selected steps of another communication process with local breakout, in accordance with selected aspects described in this document.

FIG. 7A illustrates selected parts of a system with multiple on-premises equipment configured for local breakout, in accordance with selected aspects described in this document.

FIG. 7B illustrates selected parts of another system with multiple on-premises equipment configured for local breakout, in accordance with selected aspects described in this document. and

FIG. 7C illustrates selected parts of a yet another system with multiple on-premises equipment configured for local breakout, in accordance with selected aspects described in this document.

The figures are not intended to be exhaustive or to limit the claimed invention to the precise form disclosed. It should be understood that the disclosed method and apparatus can be practiced with modification and alteration, and that the legal protections should be limited only by the claims and the equivalents thereof.

### DETAILED DESCRIPTION

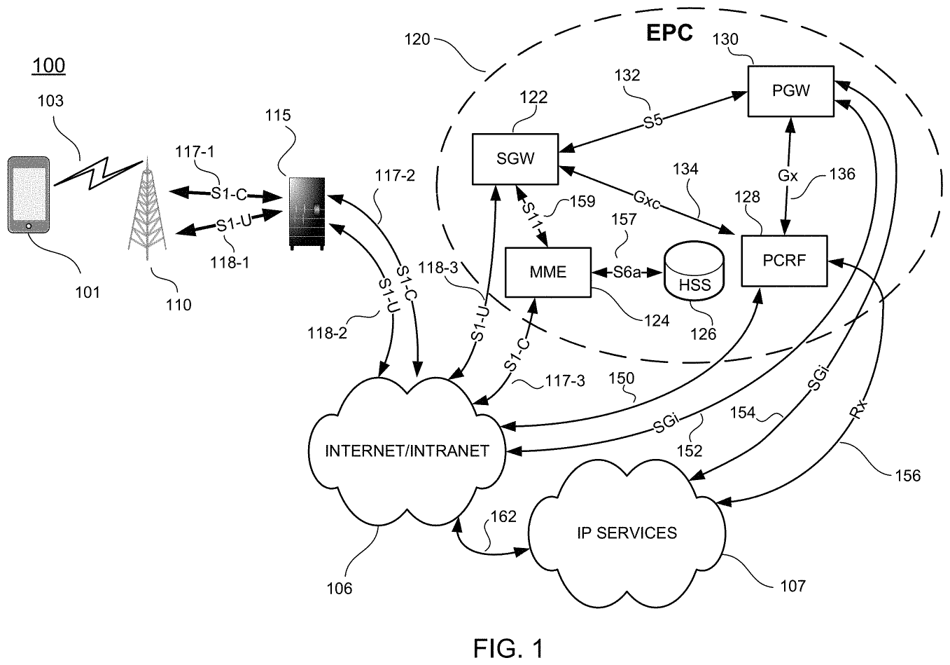

FIG. 1 illustrates selected parts of a system 100 comprising: one or more User Equipment devices (UEs) 101; the Internet 106; a on-premises router/modem 115, such as a home or an enterprise router/modem (hereafter referred to simply as a modem for the sake of simplicity); a 4G LTE (fourth generation Long-Term Evolution) cellular communication network that includes an Evolved Node B (eNB) 110 and a network core (i.e., an Evolved Packet Core (EPC) 120); and various IP Services and Resources 107. While the example shown in FIG. 1 comprises components of a 4G network, it should be understood that the method and apparatus disclosed herein is applicable to 5G NR (fifth generation New Radio) networks, as well as other communications networks.

The UE 101 may be, for example, a cellular smartphone, an Internet of Things (IoT) apparatus, virtual reality goggles, smart glasses (e.g., Google glass), a tablet, a computer (laptop, desktop), a vehicle (conventional, autonomous, semi-autonomous), a robotic device, a wireless sensor (fixed, mobile), a health/fitness monitor, or a barcode scanner. This enumeration of UE types is illustrative; many other wireless devices may be included in the group of devices referred to herein as UEs.

The UE 101 may include, within its enclosure, one or more processors, modems, transceivers (e.g., cellular, WiFi, Bluetooth®, etc.), storage and memory (e.g., random access memory, dynamic random access memory, read-only memory, volatile memory, non-volatile memory, etc.), cameras, screens (e.g., cathode ray tubes, touch-sensitive liquid crystal displays, etc.), acceleration sensors, speakers, microphones, batteries, and other components and subsystems.

The on-premises modem 115 may be, for example, a DSL router/modem, a cable router/modem, a fiber optic router/modem, a satellite transceiver router/modem, or an Ethernet router/modem. That is, the modem 115 is a conventional device that allows packets to be transmitted in a desired format to the internet and routed appropriately to the desired destination.

The IP Services and Resources 107 may be, for example, websites; email services; file transfer protocol (ftp) services; communication applications (apps) such as WhatsApp®, and social networks such as Facebook® and LinkedIn®. In some embodiments, the modem 115 has a WiFi receiver/transmitter (transceiver) that allows WiFi enabled devices to access the Internet. The IP Services and Resources 107 are available to the internet through a connection 162. The IP Services and Resources 107 are also available to the EPC 120 through an SGi interface/connection 154 to the EPC 120.

In some embodiments, the EPC 120 is a suite of functional modules defined by the Third Generation Partnership Project (3GPP) industry standards. This suite of functional modules includes; a Serving Gateway (SGW) 122, a Mobility Management Entity (MME) 124, a Home Subscriber Server (HSS) 126, a Policy and Charging Rules Function (PCRF) 128, and a Packet Gateway (PGW) 130, interconnected as depicted by various interfaces/connections (e.g., 132, 134, 136, 150, 152, 154, 156, 157, and 159). The EPC 120 may be implemented in a cloud service, such as a commercially available Amazon Web Services (AWS) cloud and similar/analogous computing cloud services available from Alphabet/Google, Microsoft, IBM, Oracle, and other providers. The cloud service may also be a private cloud or a combination of public and private resources. In some embodiments, the EPC may be owned and operated by a mobile network operator (MNO), such as AT&T Wireless, etc. In such case, the UE 101 would typically have a subscription to that MNO to allow the UE 101 to gain access to the EPC 120.

In some embodiments, the UE 101 communicates with the Internet and various IP services (e.g., websites, MBB, IMS, Internet of Things or IoT devices) as follows. A wireless radio frequency (RF) connection 103 is established between the UE 101 and the eNB 110. The eNB 110 is also connected to the modem 115, for example, through a wired connection such as an Ethernet connection, or alternatively through a WiFi connection. Communications between the UE 101 and the eNB 110 include two streams of data (i.e., “data flows”). The first data flow is LTE S1-C control plane data and the second data flow is LTE S1-U user plane data. The eNB 110 provides wireless access for these two data flows between the UE 101 and the modem 115. Accordingly, an S1-C data flow 117-1, and an S1-U data flow 118-1 are established between the eNB 110 and the modem 115. Note that these data flows are bidirectional. Note also that they may physically flow through the same conduit between the eNB 110 and the modem 115, such as a phone line in case of DSL, an RF cable in case of cable modem, and optical fiber in case of fiber modem, or an Ethernet connection.

The modem 115 sends and receives the control plane data S1-C and user plane data S1-U to and from the Internet. In some embodiments, the communication between the modem 115 and the internet is through an Internet Protocol Security (IPsec) network protocol link, to provide secure communications for the S1-C interface 117-2 and an S1-U interface 118-2, respectively. The control plane data S1-C and the user plane data S1-U then connect to the EPC 120 via an S1-C interface 117-3 and an S1-U interface 118-3, respectively. From the EPC 120, the user plane data connects back to the Internet via an SGi interface 152. In this way, the UE 101 gains access to the Internet and the multiple resources available on the Internet, as well as receiving telephone connectivity services through the wireless network.

When the UE initially makes contact with the eNB 110, a Non-Access Stratum (NAS) signaling protocol in accordance with the 3GPP 4G industry standard occurs. In accordance with one of the NAS functions, the UE 101 communicates through the eNB 110, which in turn communicates with the modem 115 over the S1-C interface 117-1. The modem 115 then communicates through the internet over the S1-C interface 117-2. The internet in turn communicates with the EPC 120 over the S1-C interface 117-3. In particular, the S1-C interface is received within the EPC 120 by the MME 124. In response, the MME 124 is prompted to attain an internet protocol (IP) address to be assigned to the UE 101 by the SGW 122 and PGW 130. Accordingly, the PGW 130 serves as the IP address anchor for the UE 101.

Once attached to the network, the UE 101 can access resources through the EPC 120. Since the PWG 130 within the EPC 120 is the IP address anchor, both the S1-C interface and the S1-U interface are routed through the EPC 120 for all communications with the UE 101. That is, the S1-U user plane data flow 118-3 is routed through the SGW 122 of the EPC 120, which is then routed to the PWG 130 and then on to the internet over the SGi interface 152 between the PGW 130 and the internet 106. The EPC 120 establishes the connection between the UE 101 and the resources that the UE 101 is attempting to access through the internet 106. Since the PGW 130 assigns the IP address to the UE 101, the address that is assigned is associated with the network in which the EPC 120 resides, as opposed to the local on-premises network to which the eNB 110 and modem 115 belong. Therefore, when the UE 101 makes a request for access to the IP services 107, all communications to the IP service use the IP address that the PGW 130 assigned to the UE 101. Accordingly, all user plane communications to and from the IP services 107 must go through the EPC 120.

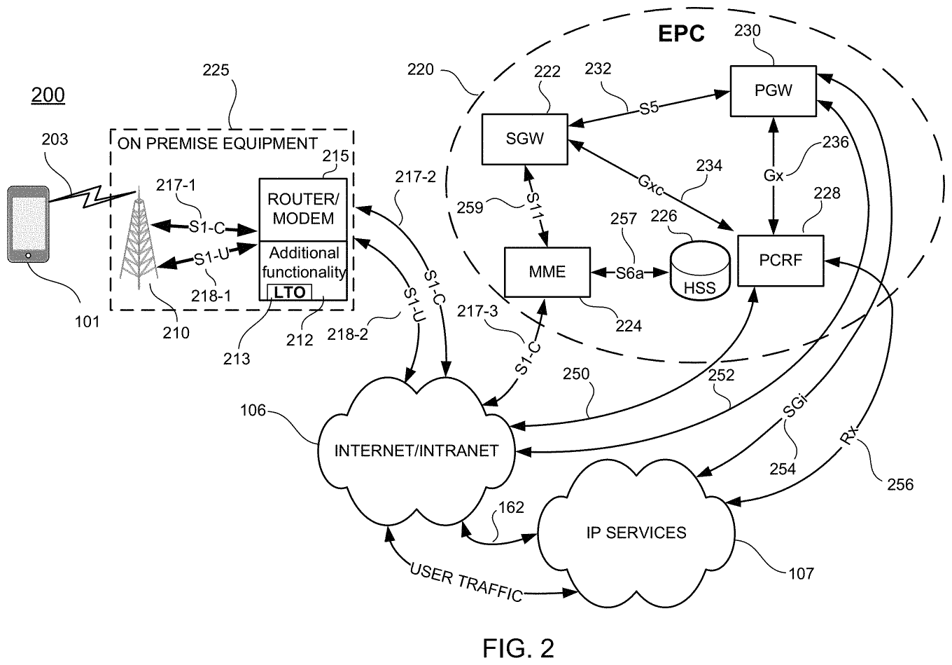

FIG. 2 illustrates selected parts of a system 200 that includes UEs 101 (one shown as an example); the Internet 106; and the IP Services and Resources 107. The system 200 also includes an EPC 220, which may be the same as, or a modified version of, the EPC 120, in which additional components may be present and/or any of the constituent components of the EPC 120 may have been modified or deleted. In some embodiments, the EPC 220 is a suite of functional modules, such as an SGW 222, an MME 224, an HSS 226, a PCRF 228, and a PGW 230, interconnected as depicted by various interfaces/connections (e.g., 232, 234, 236, 250, 252, 254, 256, 257, and 259).

When the UE 101 initially attempts to camp on the eNB 210, the eNB 210 communications over the S1-C interface 217-1 with the modem 215. The modem 215 communicates over an S1-C interface 217-2 with the internet, which then communicates over an S1-C interface 217-3 with the MME 224 within the EPC 220. However, in contrast to the case of the EPC 120 shown in FIG. 1, in some embodiments the modem 215, in coordination with additional functionality 212 and the LTO entity 213, send a locally generated IP address to the MME 224 within the EPC 220. Therefore, rather than the MME 224 attaining an IP address that is associated with the network of the EPC 220, the MME 224 maintains the locally generated IP address for the UE 101.

Since the UE 101 has a locally generated IP address, the user plane data transmitted over the S1-U 218-2 interface can directly access the IP services 107 without being routed through the EPC 220. That is because in the system 200, a locally generated IP address is assigned to the UE 101 by on-premises equipment 225. Locally generated IP addresses are IP address that are taken from a pool of on-premises IP addresses.

In other embodiments, rather than requiring a modification of the S1-C interface between the UE 101 and the MME 224 that is required to allow the locally generated IP address to be provided to the MME 224, an S11 interface is established between the additional functionality 212 within the on-premises equipment 225 and the MME 224 within the EPC 220. In such embodiments, the additional functionality 212 interacts with the MME 224 in the same way that the SGW 122 does in the EPC 120 of FIG. 1. This allows all of the conventionally specified protocols of the S1-C and S11 interfaces to remain unmodified.

Whether the MME 224 receives the locally generated address over a modified S1-C interface or over an S11 interface between the additional functionality 213 provided within the on-premise equipment, packets sourced from the internet 106 or the IP services 107 with a destination address that is a locally generated IP address will be routed directly to the on-premises equipment 225, as opposed to being routed through the EPC 220.

In addition to locally assigning and releasing IP addresses for communications between the UE and IP services accessed through the internet, the additional functionality 212 may perform other functions typically performed by the EPC 120 in the system 100. The additional functionality 212 may include a power supply for providing power to run one or more of these devices, and/or additional devices, all of which is not shown for the sake of efficiency in the figure. Alternatively, power may be provided for the on-premises equipment 225 via a Power over Ethernet (PoE) connection that allows power to be provided on an Ethernet cable that is also used to connect the on-premises equipment 225 to the internet.

Accordingly, in some embodiments of the system 200, the UE 101 accesses the Internet and various IP services (e.g., websites, MBB, IMS, Internet of Things or IoT devices) as follows.

A wireless RF connection 203 is established between the UE 101 and the eNB 210. The eNB 210 is connected to the modem 215 and to the additional functionality 212 through a connection, such as an Ethernet cable, WiFi connection, or otherwise. In some embodiments, the modem 215, the additional functionality 212, and the eNB 210 are combined into a single housing to form a node comprising all of the on-premises equipment 225 (e.g., reside within the same enclosure). In such embodiments, the connection of the LTE S1-C control plane data flow 217-1 from the eNB 210 to the modem 215 and the additional circuitry 212 may be internal to the equipment 225, thus allowing for easier installation of the on-premises equipment 225. The S1-U interfaces 218-1 and 218-2 are similar to the user plane data flows 118-1 and 118-2 discussed with respect to FIG. 1.

The modem 215 is identical or analogous to the modem 115. It may send/receive control plane data and user plane data to/from the Internet, possibly using the IPsec network protocol suite, via S1-C and S1-U interfaces 217-2 and 218-2, respectively. The control plane data is then routed through the internet to the EPC 220 via the S1-C interface 217-3.

The user plane data, however, does not need to go through the EPC 220, since the IP address of the particular IP services to which the data is directed has already been provided. Therefore, user plane data can be sent directly to the targeted Internet resources, such as websites, email and ftp servers, etc. without processing by the EPC 120. This is referred to as “local breakout” or “local user-plane bypass”.

In some embodiments, when the MME 224 determines from information received over the S1-C interface 117-3 that a connection to a PDN that is accessible through the internet has been requested, the MME 224 communicates through the SGW 222 with the PGW 230 to have an IP address assigned for the connection between the UE 101 and the PDN. The MME 224 sends the assigned IP address to the eNB 210 with establishment of each radio resource control (RRC) connection. For example, each time an RRC connection is established, the MME 224 provides the eNB 210 (or a gNB in 5G systems discussed below) with the mapping of the IP address allocation to the S1AP-MME-TEID and CRNTI. A local traffic offload (LTO) entity 213 (in some embodiments, located within the additional functionality 212 in the on-premises equipment 225) performs local traffic breakout. In some embodiments that includes performing a network address translation (NAT). These embodiments may allow for the same IP address to be assigned to the UE 101 upon independently deployed eNB 210. In some embodiments, the MME 224, PGW 230, SGW 222, and HSS 226 nodes of the EPC 220 are deployed in the cloud. Relative to the operation of the system 100 of FIG. 1, no changes are required to the S1-C interface protocol. However, in other embodiments, such changes may occur.

In accordance with some embodiments, a Dynamic Host Configuration Protocol (DHCP) server runs on-premises (e.g., in the eNB 210 and/or the circuitry 210). The DHCP server provides the IP address assigned to the UE 101 to the MME 224 for communication between the UE 101 and EPC 220 as part of the Non-Access Stratum (NAS) signaling. In some embodiments, a “DHCP renew” continues to run in order to retain the IP allocation until the MME 224 requests that the IP address be released. The DHCP may also be used for static address assignment. In other embodiments, IP address assignments are implemented from a managed local pool of IP addresses. In some embodiments, this pool can be retained in the MME 224 or the eNB 210.

Turning now to the release of the UE 101 IP address, the MME 224 and/or PGW 230 may be configured to send a release of the IP address to the eNB 210 in response to the UE 101 releasing the PDN connection with the EPC 220.

Addressing Quality of Service (QoS) flow establishment, the QoS flows can be triggered from the core network (PCRF->PGW->SGW->MME->eNB). This QoS flow establishment procedure may follow the existing 51 procedures of 4G LTE networks. In examples, when the Traffic Detection Function (TDF) implemented in the eNB needs to trigger a QoS flow establishment, the eNB sends the request to the MME, which in turn may talk to the PCRF to establish the QoS flow. Given that the control plane aspects of these core network nodes are realized in a single node, the establishment of the QoS flow can be treated similarly to the TDF trigger realized in the core network.

In embodiments of the system 200, as well as in the other embodiments described throughout this document and illustrated in the figures, the EPC may be a suite of software processes and may be implemented in a cloud, such as a commercially-available Amazon Web Services (AWS) cloud and similar/analogous computing cloud services available from Alphabet/Google, Microsoft, IBM, Oracle, and possibly other providers. The cloud may also be a private cloud system, or a combination of public and private resources. The operation described above in relation to LTE networks apply equivalently to 5G networks.

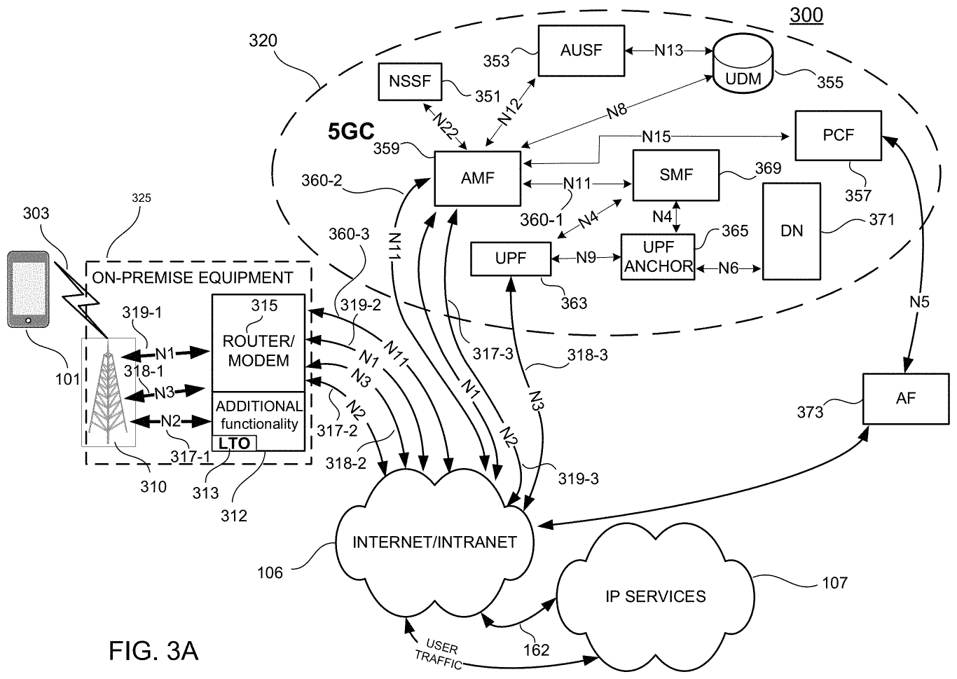

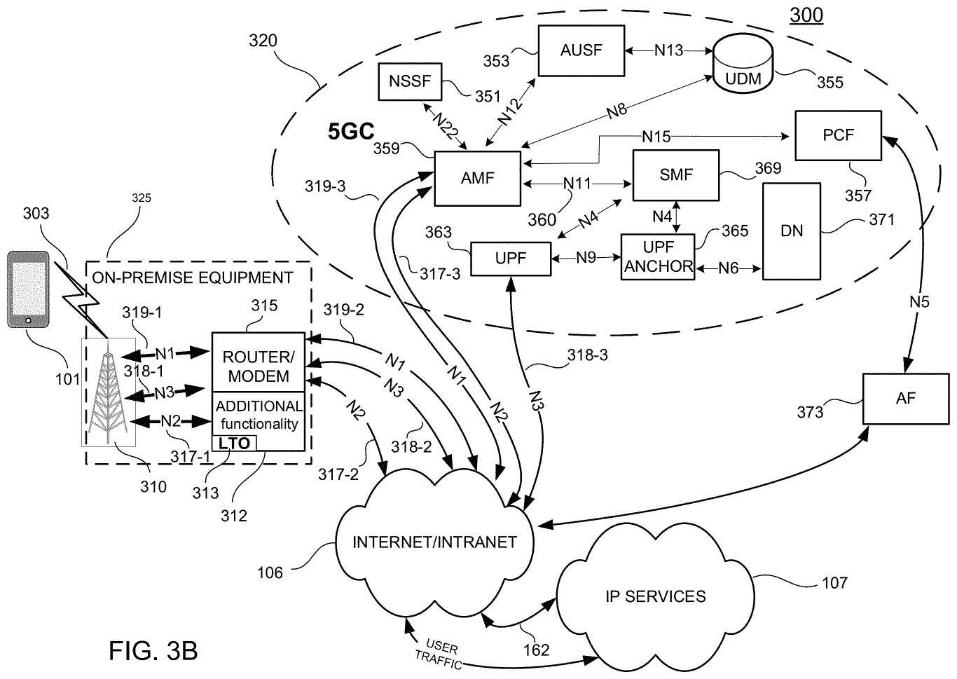

FIG. 3A illustrates selected parts of a system 300 that includes a UE 101, the Internet 106, IP Services and Resources 107 (e.g., MBB, IMS, IoTs), a gNodeB (gNB) 310, an on-premises modem 315, additional functionality 312, a 5G Core (5GC) 320, and Application Function (AF) server/process 373. The 5GC 320 may include a Network Slice Selection Function (NSSF) 351; an Authentication Server Function (AUSF) 353; a Unified Data Manager (UDM) 355; a Policy Control Function 357; an Access and Mobility Management Function (AMF) 359; a User Plane Function (UPF) 363 with its Anchor 365; a Session Management Function (SMF) 369; and Data Network (DN) 371, each of which, in some embodiments, function in accordance with industry technical standards set by 3GPP.

The additional functionality 312 is analogous to the additional functionality 212 discussed above with regard to the system 200. The additional functionality 312 may reside within the same housing as the gNB 310, the modem 315, a WiFi transceiver (not shown), a power supply (not shown) for providing power to operate one or more of these devices. In some embodiments additional devices may also be present. The combination of the gNB 310, modem 315 and additional functionality 312 is referred to as on-premises equipment 325. Any other devices that are co-located with these components would also be considered to reside within the on-premises equipment 325.

In some embodiments, the UE 101 communicates with the Internet and various IP services (e.g., websites, MBB, IMS, Internet of Things or IoT devices) as follows. A cellular RF connection 303 is established between the UE 101 and the gNB 310, similar to the operation of the systems 100/200 discussed above. The gNB 310 is connected to the modem 315 and to the additional functionality 312 through a wired connection, such as an Ethernet connection, WiFi, etc. In some embodiments in which the modem 315, the additional functionality 312, and the gNB 310 share a common enclosure, the gNB 310 connection to the modem 315 and the additional on-premises circuitry 310 are internal to the enclosure. Data flows in accordance with N1/N2/N3 interfaces 319-1/317-1/318-1, as defined by 3GPP, may be internal to the housing in which the on-premises equipment 325 resides.

In some embodiments, the modem 315 sends/receives the N1, N2, and N3 data flows 319-2, 317-2, 318-2 to/from the Internet. In some embodiments, such communications occur over an IPsec network protocol suite. The N1 and N2 data flows 319-3 and 317-3 traverse the internet, flowing to/from the AMF 359 within 5GC 320.

The user plane data communicated via the N3 interface 318-2, however, connects directly through the internet to the targeted Internet resources (i.e., IP services, such as websites, email and ftp servers, etc.). As in the case of the system 200 of FIG. 2, such arrangement may be referred to as local breakout or local user-plane bypass.

In a conventional system, when a UE 301 attempts to camp on the gNB 310, the AMF 359 within the 5GC 320 contacts the SMF 369 over an N11 interface 360-1 to attain an IP address to be assigned to the UE 301. However, in accordance with some embodiments of the disclosed method and apparatus, the AMF 359 establishes an N11 interface 360-2, 360-3 through the internet 106 to the additional functionality 312 within the on-premises equipment 325. Using that N11 interface, the AMF 359 requests that the additional functionality 312 perform similar to the manner in which the SMF 369 would in providing an IP address. However, the IP address provided by the additional functionality 312 is an IP address that is local to the on-premises equipment. In some embodiments, that function is performed by an LTO entity 313, which in some embodiments resides in the equipment 325. In some embodiments, the IP address is assigned to the UE 301 by the gNB 310. In some such embodiments, a user plane function (UPF) is integrated in the gNB 310 to assign the local IP address. It should be noted that no changes are required to the N1 or N2 interfaces.

FIG. 3B is an illustration of another embodiment in which the additional functionality 312 provides a locally generated IP address for the UE 301 when the UE 301 camps on the gNB 310. That locally generated IP address is then provided to the AMF 359 within the 5GC 320. Accordingly, the AMF 359 does not need to attain an IP address for the UE 301 from the SMF 369.

As in the LTE 4G examples, a Dynamic Host Configuration Protocol (DHCP) server may run locally (e.g., in the gNB 310 and/or the additional functionality 312) and provide the IP address assigned to the UE 301 to the 5GC 320 for communication with the UE 301. The DHCP renew may continue to run in order to retain the IP allocation until the IP address is to be released. The DHCP may also be used for static address assignment. Alternatively, IP address assignment for the UE 301 may be implemented as a managed local pool of IP addresses. This pool can be retained, for example, in the 5GC 320 or the gNB 310. Since the UE 301 is assigned an IP address that was locally generated within the on-premises equipment 325 (i.e., the IP address anchor for the UE is within the on-premises equipment 325, user plane flows need not flow through the 5GC 320. Rather, such user plane flows can flow directly between the on-premises equipment 325 and the internet 106.

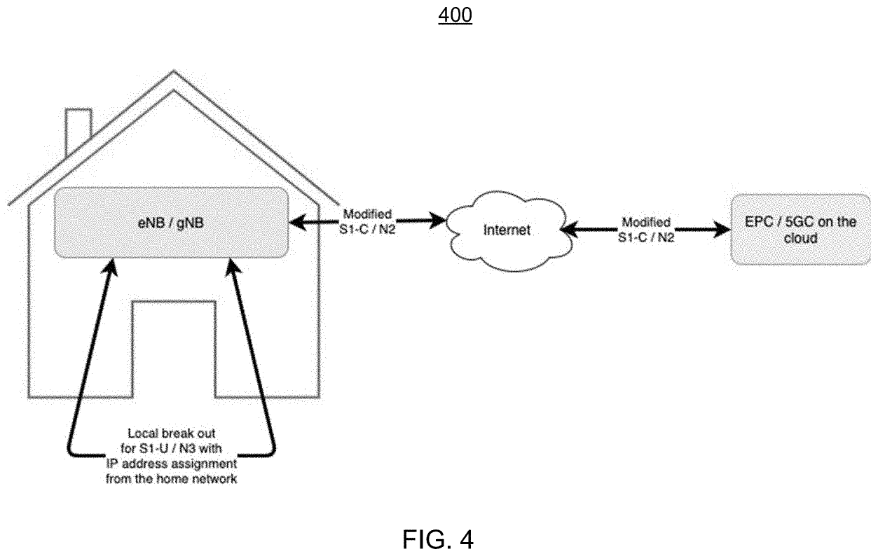

FIG. 4 illustrates selected parts of an example of modified 4G/5G network architecture with local breakout, in which the user plane data S1-U/N3 is not sent to or processed by the EPC/5GC.

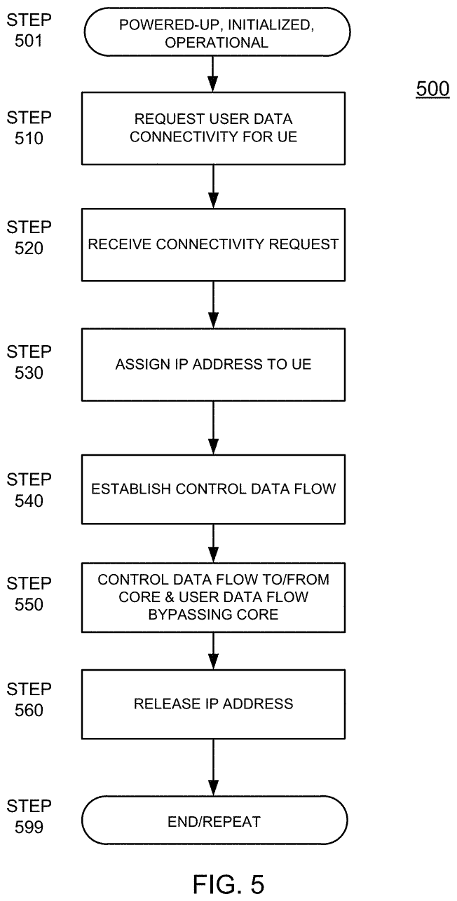

FIG. 5 shows selected steps of a process 500 illustrating an example of operation of local breakout.

At step 501, the UE and the network are powered up, initialized, and operational.

In step 510, the UE requests PDN/PDU user plane data connectivity.

In step 520, the request is received by the on-premises equipment, which may include eNB/gNB, WiFi, router/modem, additional on-premises circuitry, and a power supply that powers these devices.

In step 530, an IP address is assigned by the on-premises equipment and the UE is notified of its IP address.

In step 540, control plane data flow between the UE and the EPC/5GC (through the on-premises equipment) establishes communication parameters (such as RF channel assignment) for the communication link between the UE and the on-premises equipment.

In step 550, the UE communicates user-plane data with the Internet and/or an Intranet through the on-premises equipment, bypassing the EPC/5GC of the cellular network; the S1-C/N2 control signaling continues to flow through the EPC/5GC.

In step 560, the on-premises equipment determines that the UE's IP address may be released (e.g., receiving a release request or sensing the UE's disconnect), and releases the IP address.

The process 500 may then terminate at step 599, and may be repeated as needed or desired.

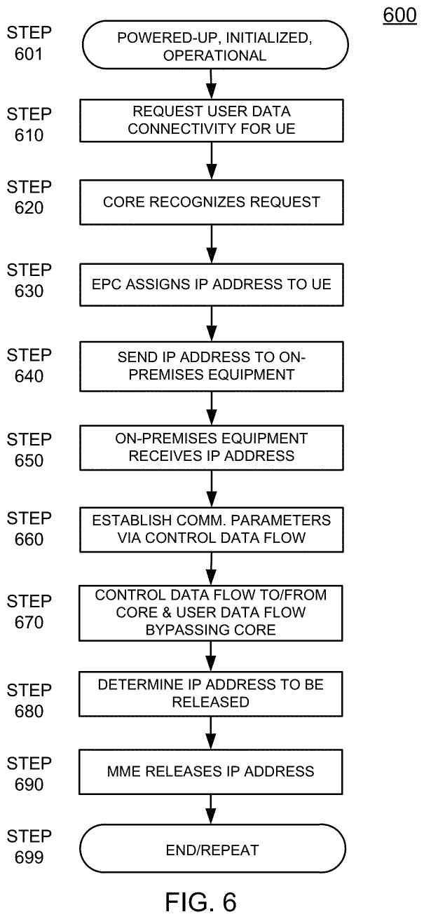

FIG. 6 shows selected steps of a process 600 illustrating another example of operation of local breakout.

At step 601, the UE and the network are powered up, initialized, and operational.

In step 610, the UE requests PDN/PDU user plane data connectivity.

In step 620, the request is recognized by the EPC, for example, by the MME of the EPC.

In step 630, an IP address is assigned to the UE, for example, by the PGW of the EPC.

In step 640, the EPC sends the assigned IP address to the on-premises eNB or gNB, for example, by the MME of the EPC.

In step 650, the assigned IP address is received by the eNB/gNB.

In step 660, control plane data flow between the UE and the EPC/5GC (through the on-premises equipment) establishes communication parameters (such as RF channel assignment) for the cellular communication link between the UE and the on-premises equipment.

In step 670, the UE's user plane data flows between the UE and the Internet and/or an Intranet through the on-premises equipment, bypassing the EPC/5GC of the cellular network; the S1-C/N2 control signaling continues to flow through the EPC/5GC.

In step 680, the on-premises equipment determines that the UE's IP address may be released (e.g., receiving a release request or sensing the UE's disconnect), and notifies the MME to release the IP address.

In step 690, the MME releases the IP address.

The process 600 may then terminate at step 699, and may be repeated as needed or desired.

It should be noted that multiple eNBs may be deployed on the same premises or enterprise campus. Similarly, multiple gNBs may be deployed on the same premises/campus. Additionally, one or more eNBs may be deployed in conjunction with one or more gNBs on the same premises/campus. Thus, a system may employ two or more Nodes B (NBs) of the same or different types on the premises/campus. Note also that one or more (possibly all) the NBs may share a router/modem (such as the modem, 215 or 315), and multiple NBs (possibly all) may share additional functionality such as the additional functionality 212 (for 4G operation) or 312 (for 5G operation), whether the router/modem and the additional functionality (and possibly other devices such as a WiFi transceiver and a power supply) are bundled together or not. In the case of multiple NB s sharing additional functionality, the additional functionality may be modified to accommodate the multiple NBs, particularly if the NBs are of different types.

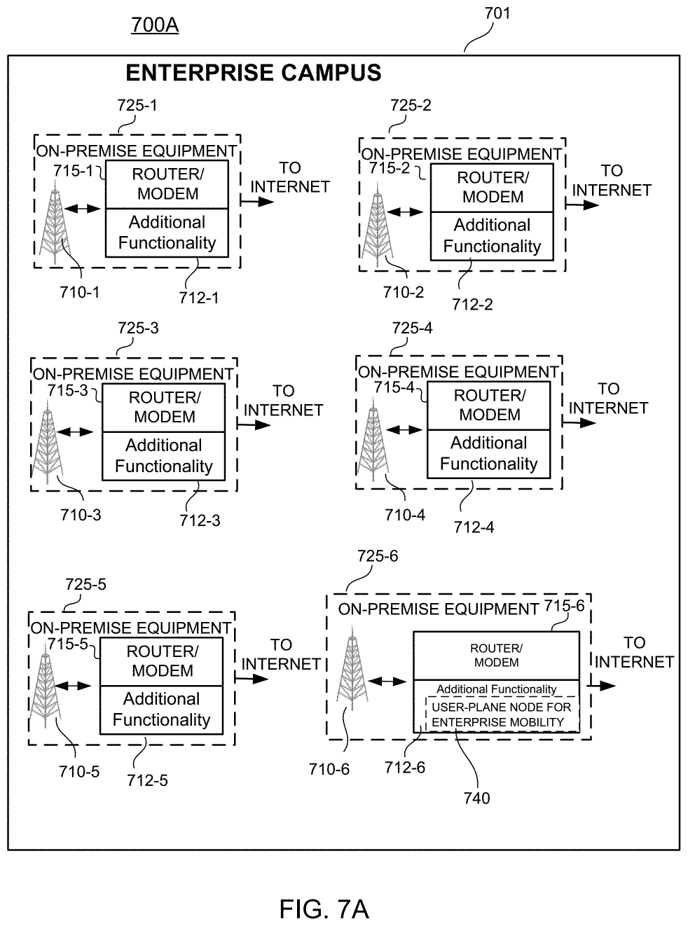

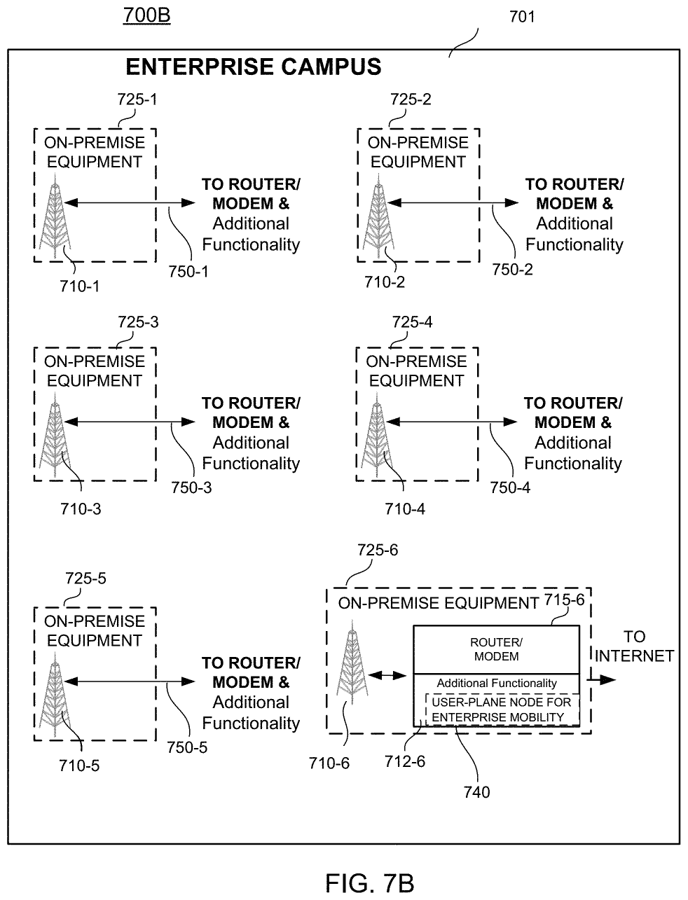

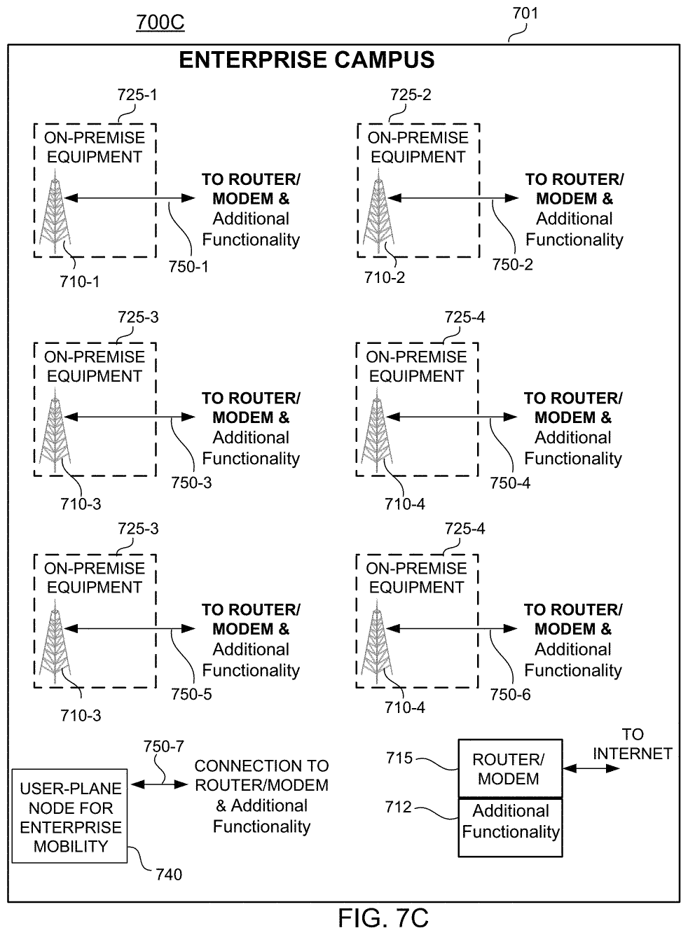

FIG. 7A illustrates selected parts of a system 700A with multiple on-premises equipment 725-n, on-premise/campus 701. Each on-premises equipment 725-n may include a BS/AP 710-n, a modem 715-n, and additional functionality 712-n. As shown, the first three on-premises equipment 725-1 through 725-3 are configured as on-premises equipment 225 described in relation to FIG. 2; the three remaining on-premises equipment apparatus 725-4 through 725-6 are configured as on-premises equipment 325 described in relation to FIG. 3. As has already been mentioned, the modem of each on-premises equipment 725 may (but need not) be combined with the additional functionality of that equipment (and possibly other devices). The on-premises equipment 725 may be spread out on different floors and floor locations of the premises, and may provide overlapping or non-overlapping cellular coverage on the premises/campus and possibly beyond the premises/campus. The system 700A also includes an Integrated User-Plane node 740 that allows UE mobility across the eNBs/gNBs (and/or other BS/APs) without disruption of packet session continuity and allowing soft handoff/handover of UE calls. As shown, the node 740 is part of the on-premises equipment 725-6. The node 740 may also be bundled together with the additional functionality 712-6, for example, in the same enclosure. In other embodiments, the functionality of the node 740 may be distributed among two or more of the on-premises equipment 725 and their additional functionality 712. The node 740 may also be a standalone node, for example, connected by a cable to one or more of the on-premises equipment 725.

FIG. 7B illustrates selected parts of a system 700B, which is similar to the system 700A. Here, however, several (possibly all) of the on-premises equipment 725-n are connected to the same modem 715 and additional functionality 712 by connections 750-n, which may be wired (e.g., RF cable, Ethernet) or wireless. Because of multiple on-premises equipment of different types, the additional functionality 712 is capable of (and configured to) provide the local breakout functionality to multiple BS/APs including eNBs and gNBs 725, as well as other BS/APs (not shown). As in the system 700A, the Integrated User-Plane node 740 allows UE mobility across the BS/APs of the system 700B without disruption of packet session continuity and allowing soft handoff/handover of UE calls. The node 740 may be part of any of the on-premises equipment 725, may be bundled with the additional functionality 712 of any of the equipment 725, may be a standalone node, and may be a node “distributed” among several of the equipment 725.

FIG. 7C illustrates selected parts of a system 700C, which is similar to the system 700B. Here, however, the modem 715 and the additional functionality 712 are not combined with one of the BS/APs. Rather, the circuitry 712 and the modem 715 constitute separate node(s). The node 740 is also a standalone (separate from the equipment 725) node. Each on-premises equipment 725-n connects to the modem 715 and the additional functionality 712 (and through them, to the Internet) via connections 750-1 through 750-6. The node 740 also connects to the modem 715 and to the additional functionality 712 via a connection 750-7.

Although the process steps may be described serially in this document, certain steps and/or decisions may be performed by same and/or separate elements in conjunction or in parallel, asynchronously or synchronously, in a pipelined manner, or otherwise. There is no particular requirement that steps be performed in the same order in which this description lists them or the Figures show them, except where a specific order is inherently required, explicitly indicated, or is otherwise made clear from the context. Furthermore, not every illustrated step may be required in every embodiment in accordance with the concepts described in this document, while some steps that have not been specifically illustrated may be desirable or necessary for proper operation in some embodiments in accordance with the concepts. It should be noted, however, that specific embodiments/variants/implementations/examples use the particular order(s) in which the steps are shown and/or described.

The instructions (machine executable code) corresponding to the method steps of the embodiments, variants, implementations, and examples disclosed in this document may be embodied directly in hardware, in software, in firmware, or in combinations thereof. A software/firmware module may be stored in volatile memory, flash memory, Read Only Memory (ROM), Electrically Programmable ROM (EPROM), Electrically Erasable Programmable ROM (EEPROM), hard disk, a CD-ROM, a DVD-ROM, or other forms of non-transitory storage medium known in the art. Exemplary storage medium or media may be coupled to one or more processors so that the one or more processors can read information from, and write information to, the storage medium or media. In an alternative, the storage medium or media may be integral with one or more processors.

Although the disclosed methods, apparatus, and articles of manufacture are described above in terms of various examples, embodiments, variants, and implementations, it should be understood that the particular features, aspects and functionality described in one or more of the individual embodiments are not limited in their applicability to the particular embodiment with which they are described. Thus, the breadth and scope of the claimed invention should not necessarily be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The words “couple,” “connect,” and similar words/phrases/expressions with their inflectional morphemes do not necessarily import an immediate or direct connection, but include within their meaning connections through mediate elements. Unless otherwise noted or is clear from the context, devices may be coupled/connected wirelessly, optically, and in a wired manner. Connections may include buses and various network(s), including local area networks (LANs) and wide area networks (WANs) such as the Internet.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Some definitions and clarifications have been explicitly provided above. Other and further explicit and implicit definitions and clarifications of definitions may be found throughout this document and the incorporated document(s).

Additionally, the various embodiments set forth herein are described with the aid of block diagrams, call flow chart(s), and other illustrations. As will become apparent to one of ordinary skill in the art after reading this document and examination of the attached drawings, the illustrated embodiments and their various alternatives can be implemented without confinement to the illustrated examples. For example, block diagrams and their accompanying description should not be construed as mandating a particular architecture or configuration.

The features and aspects described throughout this document and the incorporated document may be present individually, or in any combination or permutation, except where the presence or absence of specific features (elements/steps/limitations) is inherently required, explicitly indicated, or is otherwise made clear from the description. This applies whether or not features appear related to specific embodiments; thus, features of the different described embodiments may be combined.

What is claimed is:

1. On-premises equipment comprising:
a) a base station/access point (BS/AP) configured to wireless communicate with user equipment (UE);
b) additional functionality configured to assign a locally generated internet protocol (IP) address to the UE; and
c) a modem, coupled to the BS/AP and to the additional functionality, the modem configured to communicate through the Internet with a network core and to provide the network core with the locally generated IP address of the UE;
wherein the user plane communications received from the UE are routed by the modem to the internet and responsive communications from the internet are routed to the modem based on the locally generated IP address.

2. The on-premises equipment of claim 1, wherein the communication through the Internet with the network core is directed to a mobility management entity (MME) within the network core.

3. The on-premises equipment of claim 2, wherein the MME operates in accordance with Third Generation Partnership Project (3GPP) industry standard technical specifications.

4. The on-premises equipment of claim 1, wherein providing the locally generated IP address to the UE establishes the anchor for the UE IP address within the on-premises equipment.

5. The on-premises equipment of claim 1, wherein the communication between the modem and the MME occurs over a modified S1-C interface, the modification providing a means by which the locally generated IP address assigned to the UE is provided to the MME.

6. The on-premises equipment of claim 3, wherein the communication between the modem and the MME occurs over an S11 interface over which the MME receives the locally generated IP address from the modem in response to the communications received from the MME over the S11 interface.

7. The on-premises equipment of claim 6, wherein the BS/AP is a 4^{th} generation Long Term Evolution (LTE) compliant eNodeB (eNB).

8. The on-premises equipment of claim 1, wherein communications from the modem to the internet include requests for services to be provided by an IP service accessible through the internet.

9. The on-premises equipment of claim 1, wherein the additional functionality performs functions similar to at least some functions performed by a serving gateway and packet gateway of a 4^{th} generation LTE compliant evolved packet core.
